(19) United States
(12) Patent Application Publication
(10) Pub. No.: US 2008/0257692 A1
(43) Pub. Date: Oct. 23, 2008

(54) SENSOR SYSTEM FOR CONVEYOR BELT

(75) Inventor: Jack Bruce Wallace, Powell, OH (US)

Correspondence Address: WOOD, HERRON & EVANS, LLP, 2700 CAREW TOWER, 441 VINE STREET, CINCINNATI, OH, 45202, US

(73) Assignee: VEYANCE TECHNOLOGIES, INC., Fairlawn, OH (US)

(21) Appl. No.: 12/133,815

(22) Filed: Jun. 5, 2008

(51) Int. Cl. B65G 43/06

(52) U.S. Cl. 198/810.02

(57) ABSTRACT

A conveyor belt includes at least one rip detection sensor having at least two cords, each cord formed in an endless loop and arranged in a signal inverting configuration, and at least one cross connector connecting the at least two cords so as to arrange the at least two cords in a parallel configuration. The sensor provides a redundancy feature such that should one cord break, the remaining cord allows the sensor to continue operation. The parallel configuration of the cords reduces overall resistance of the sensor and extends the sensor life as the conveyor belt wears.

### TECHNICAL FIELD

The invention relates generally to conveyor belts having electrically conductive sensor loops embedded therein and, more particularly, to a sensor system for a conveyor belt for detecting and locating belt degradation and damage.

### BACKGROUND

In a multitude of commercial applications, it is common to employ a heavy duty conveyor belt for the purpose of transporting product and material. The belts so employed may be relatively long, on the order of miles, and represent a high cost component of an industrial material handling operation. In many applications, the belts are susceptible to damage from the material transported thereby and a rip (slit, cut or tear) may develop within the belt. A torn or ripped belt can be repaired once detected. The cost of repairing a heavy duty conveyor belt and the cost of cleaning up material spilled from the damaged belt can be substantial. If, however, such a rip or tear commences and the belt is not immediately stopped, the rip can propagate for a substantial distance along the belt. It is, therefore, desirable to detect and locate a rip in the belt as quickly as possible after it commences and to immediately terminate belt operation, whereby minimizing the extent of the damage to the belt.

It is well known to employ sensors within conveyor belts as part of a rip detection system. In a typical system, sensors in the form of loops of conductive wire are affixed or embedded in the belt and provide a rip detection utility as part of an overall rip detection system. Rip detection is achieved through the inferential detection of an “open circuit” condition in one or more of the sensor loops in the belt. Typically, an electrical energy source external to the belt is inductively or capacitively coupled to a sensor loop in the belt. A break in the conductive loop of the sensor may be detected by a remote transmitter/receiver (exciter/detector). Disposition of a plurality of such sensors at intervals along the conveyor may be effected with each sensor passing within read range of one or more exciter/detectors at various locations. A rip or tear will encounter and damage a proximal sensor loop and the existence of the tear will be detected when the proximal sensor loop damage is detected as an open circuit by the reader at its next pass. In this manner, the existence of a tear will be promptly detected and repaired and damage to the belt therefrom minimized.

U.S. Pat. No. 3,742,477 (Enabnit; 1973) discloses a “figure eight” sensor loop useful within belt sensor system. U.S. Pat. No. 4,854,446 (Strader; 1989) teaches a “figure eight” sensor loop disposed at intervals along a conveyor belt. U.S. Patent No. 6,352,149 (Gartland; 2002) provides a system in which antennae are embedded in a conveyor belt to couple with an electromagnetic circuit consisting of two detector heads and an electronic package. Coupling occurs only when an antenna passes across the detector heads and can only occur when the loop integrity has not been compromised.

U.S. Pat. No. 6,715,602 (Gartland; 2004) discloses a sensor system in which sensors are embedded at predetermined intervals along a conveyor belt. A detector detects the presence or the absence of a sensor and that information is used to evaluate the condition of the belt at the sensor location. While the system works well, certain data interpretation problems exist. The transponders (e.g., RFID tags) used in the belt and the information they provide may not be reliable for use in drawing critical conclusions. For example, if the tags are not read, the system is configured to shut the belt down. Such a disruption may or may not be necessary given the location of the tag in the belt and whether the failure to detect the tag should be interpreted as a belt failure (e.g., rip in the belt).

It is, therefore, important that the system not shutdown automatically if the tag(s) are not detected. In addition, it is desired that the reading of sensors along the belt be synchronized in a reliable manner that minimizes the possibility of faulty identification of sensor location or faulty detection of sensor malfunction. U.S. Publication No. 2007/0102264 (Wallace; 2007) addressed some of these shortcomings by separating the RFID tag from a dedicated sensor loop such that a failure of an RFID tag does not render the sensor inoperable. Instead, the sensor is correlated to other RFID tags in the conveyor belt such that should one RFID tag fail, the sensor may be read based on the other RFID tags. This is important as the conveyor system ages and sensor operation becomes intermittent.

In many prior sensor systems, a single cord loop is utilized. Such a single cord loop, however, has some drawbacks. By way of example, as the conveyor system ages, the cord that forms the loop begins to deteriorate. As a result, the resistance of the cord increases, which may result in a decrease in the couple strength of the sensor loop. The decrease in the signal transmitted through the cord may in turn result in the inability to detect the sensor loop (e.g., intermittent operation). Additionally, due to wear, fatigue, or other localized events, the cord that forms the sensor loop may break without an associated tear in the belt at that location. In either situation, the conveyor system may be configured to shut the belt down. Again, the disruption in belt operation due to the inability to read the sensor loop may or may not be necessary depending on whether the failure to detect the sensor should be interpreted as a belt failure.

Accordingly, there is a need in the industry for an improved conveyor belt sensor system that minimizes the faulty identification of belt failure resulting from a weak signal through the sensor loop due to increased resistance of the cord or from a break in the single cord loop.

### SUMMARY

An embodiment of the invention that addresses these and other drawbacks provides a conveyor belt having at least one rip detection sensor. The sensor including at least two cords, each cord formed in an endless loop and arranged in a signal inverting configuration, and at least one cross connector connecting the at least two cords so as to arrange the at least two cords in a parallel configuration that reduces the overall resistance of the sensor. In an exemplary embodiment, the two cords may have a nested configuration and may be formed from steel strands in a standard cord construction. Alternatively, the cords may be formed from one or more microcoil spring wires. The conveyor belt may include a plurality of sensors spaced at intervals along the conveyor belt.

In another embodiment, a conveyor belt rip detection system includes a conveyor belt and at least one sensor associated with the conveyor belt wherein the sensor includes at least two cords, each cord formed in an endless loop and arranged in a signal inverting configuration, and at least one cross connector electrically connecting the at least two cords so as to arrange the cords in a parallel configuration that reduces the overall resistance of the sensor. The conveyor belt rip detection system may further include an external transmitter/exciter for inducing a signal in the sensor and a first receiver/detector for detecting the presence of a signal induced in the sensor by the transmitter/exciter to monitor the integrity of the cords. The conveyor belt rip detection system may further include a drive motor, a driven roller driven by the drive motor, a following roller, and control circuitry coupled to a drive motor controller for controlling the action of the drive motor.

A method of manufacturing a sensor system for a conveyor belt includes providing at least one sensor, the at least one sensor including at least two cords, each cord formed in an endless loop and arranged in a signal inverting configuration, and at least one cross connector electrically connecting the at least two cords so as to arrange the at least two cords in a parallel configuration that reduces the overall resistance of the at least one sensor, and embedding the sensor within the conveyor belt.

These and other objects, advantages and features of the invention will become more readily apparent to those of ordinary skill in the art upon review of the following detailed description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIGS. 1A and 1B are schematic illustrations of prior art sensor systems for a conveyor belt;

FIG. 2 is a schematic illustration of another prior art sensor system for a conveyor belt;

FIG. 3 is an exemplary block level diagram of the prior art sensor system shown in FIG. 2;

FIG. 4 is a schematic illustration of another prior art sensor system for a conveyor belt;

FIG. 5 is an exemplary block level diagram of the prior art sensor system shown in FIG. 4;

FIG. 6 is a schematic illustration of a conveyor belt and sensor system in accordance with an embodiment of the invention; and

FIG. 7 is a schematic illustration of a sensor used in the sensor system shown in FIG. 6 in accordance with an embodiment of the invention.

### DETAILED DESCRIPTION

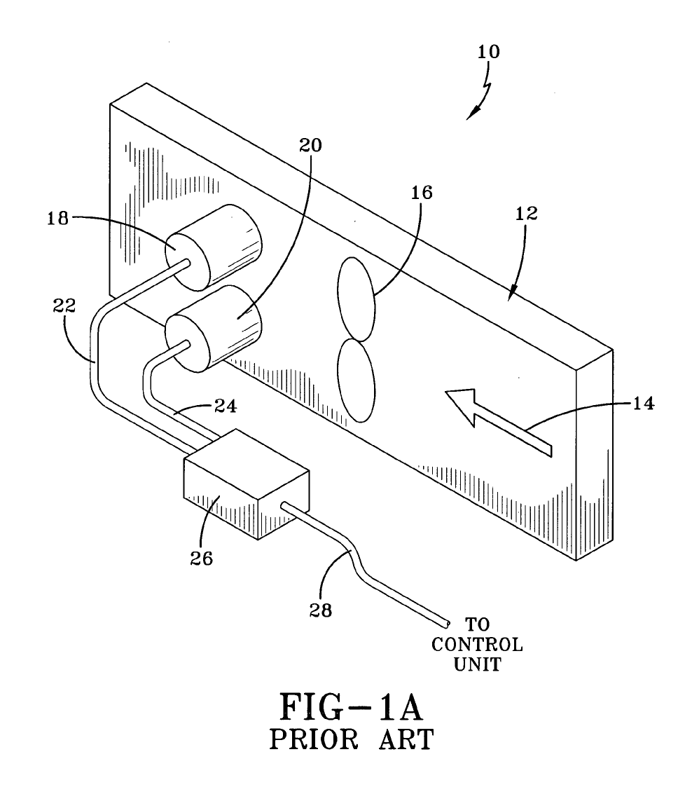

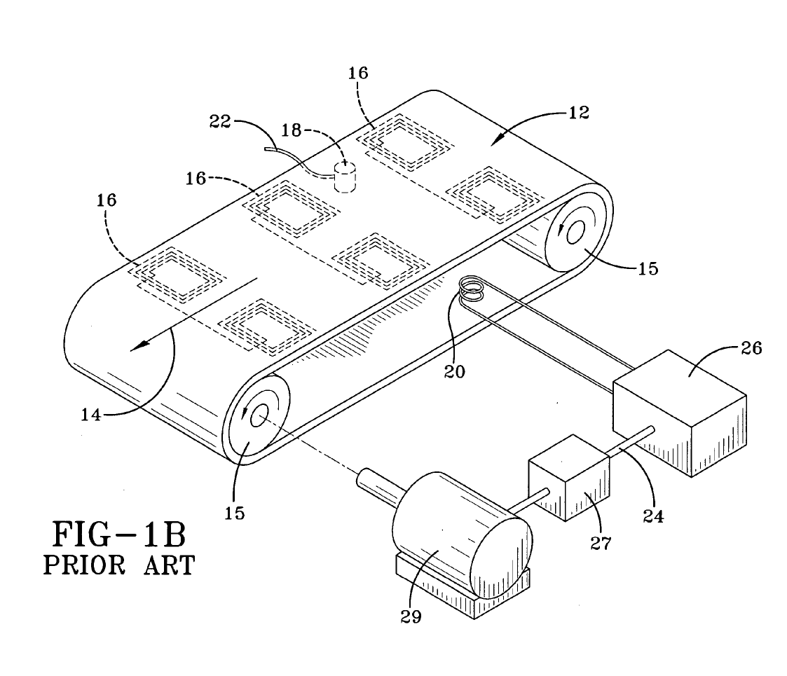

Referring initially to FIGS. 1A and 1B, a prior art conveyor belt rip detection system 10 is shown of the type taught in U.S. Pat. No. 6,352,149, incorporated herein by reference in its entirety. The system comprises conveyor belt 12 that travels in a direction 14 driven by rollers (or pulleys) 15. A series of spaced apart conductors or sensors 16 are embedded within the conveyor belt 12. Each conductor 16 may be formed in an endless loop arranged in a “FIG. 8” configuration. The sensor is configured for incorporation within the conveyor belt 12 of conventional structure having a top load bearing surface, a middle carcass layer, and a pulley cover. The sensor 16 may be embedded within any of the three layers. The rip detection system includes an external transmitter/exciter 18 and one or more receiver/detectors 20 of a commercially available type. The devices 18, 20 are routed by leads 22, 24, respectively, through a junction box 26 to a motor controller 27 via lead 28. Controller 27 controls drive motor 29 that operatively drives the rollers 15. The system sensors 16 may be spaced apart from each other and embedded in the elastomeric conveyor belt 12 transverse to the direction of belt travel 14.

The conductors/sensors 16 may use either magnetic or electric fields for excitation/detection. The conductors 16 carry a current flow therein when subjected to an electrical or magnetic field. A rip in the belt 12 will eventually propagate far enough to cause one of the conductors 16 to be broken. The transmitter 18 emits an electrical or magnetic field that is communicated by conductors 16 to a receiver 20 provided the conductor 16 is intact. Receiver 20 provides a signal to control circuitry that processes the signal and indicates a rip. The rip signal may result in an alarm and/or a signal to the motor controller 27 to automatically stop the motor 29 driving the belt 12 and shut down the conveyor belt 12.

A discontinuity in at least one of the sensors 16 will be detected by the detector(s) 20 and the belt 12 stopped. The system represented in FIGS. 1A and 1B protects by using antennae 16 embedded in the belt 12. During normal operation, the two detector heads 20 may be mounted equidistant from the edges of the belt such that the largest area of the antenna loops pass over the detector heads as the belt cycles. When the system couples with a passing loop, a resonance peak is generated and the system resets its time or distance counters and associated targets. If a rip occurs in the belt and the integrity of a loop is compromised, the electromagnetic circuit will no longer detect the loop and a stop signal is triggered, limiting the amount of damage to the belt. Separation of the loops 16 in the belt may be monitored in terms of time or distance.

In the time mode, the system will wait a given amount of time before it expects to detect a loop. If this set time is exceeded without detecting a loop, the system will trip a relay and shut the belt down. This approach is limited in that it does not correlate to the actual motion of the belt and the degree of protection is highly dependent on the speed of the belt.

In the distance mode, there are two options: standard distance and pattern distance. The standard distance mode is not dependent on the speed of the belt but rather utilizes a proximity sensor or encoder to determine the position of the loops. The system scans the belt and determines the largest distance separating any two loops in the belt and protects to that distance. With the pattern mode, the system synchronizes on the smallest loop separation during calibration and protects the belt for each subsequent loop separation in order. In this functional mode the system monitors the sensor pattern in the belt in order to protect. A difficulty, however, is encountered when the sensor pattern within the belt is irregular or has been modified by loss of one or more sensors, or a repair of the belt that results in an alteration in the spacing between belt sensor loops.

With regard to prior art systems of the type previously described, several limitations will be apparent. First, the prior art system synchronizes on the smallest gap in the belt in order to determine its location on the belt. The sensor loop locations in the belt and loop signal are not correlated for loop identification, making troubleshooting relatively imprecise. In the prior art system of FIGS. 1A and 1B, the reader is programmed to look for a loop at a certain interval (time or distance). If the belt position changes from slippage or the like, the synchronization between the reader and the loop sensors is inhibited, throwing the system out of sync. In such an event, the system must re-synchronize the reader to the sensor pattern in order to resume its rip monitoring duty. If a belt has been repaired and the pattern of sensor loops within the belt altered, the same problem will arise; that is, the reader will not “know” the sensor pattern within the belt has been modified.

Because a sensor's location within the belt is not precisely ascertainable when a rip occurs in such systems, a “Stop on Command” is not reliable. The belt must be stopped and physically examined in order to know the precise location of belt damage or an area of interest on the belt. The belt cannot, without a “Stop on Command” capability, be reliably stopped at a position that would be the most convenient from which to effect belt repair or inspection. Additionally, in such systems, the configuration of the loop design is relatively rigid and inflexible. Because existing systems use analog signals to ascertain the integrity of the loop, the systems are also vulnerable to misreadings due to extraneous “noise” and/or electromagnetic interference. Moreover, existing systems cannot readily facilitate wear rate monitoring with their sensor configurations and the systems are prone to premature failure from breakage of the sensor loops by stress forces encountered through normal operation of the belt.

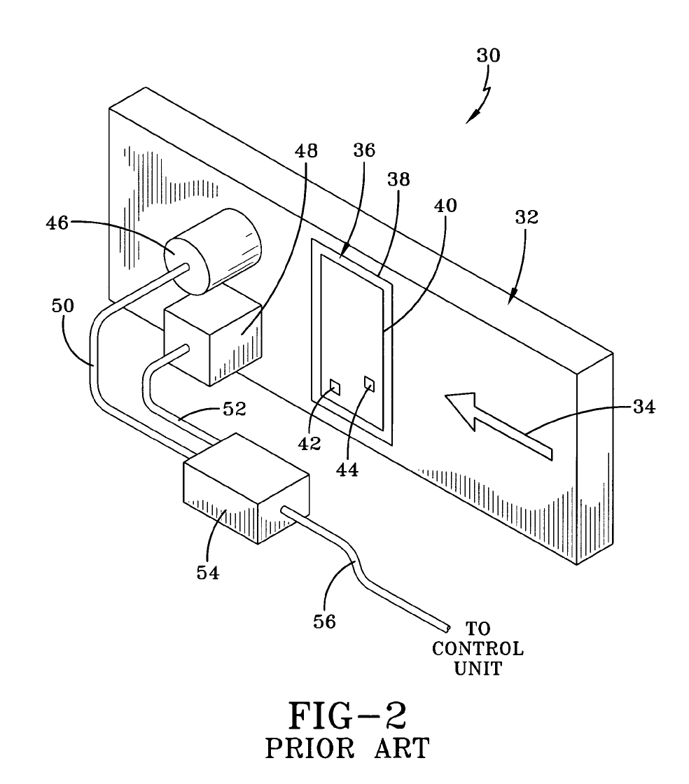

Referring to FIG. 2, a prior art conveyor belt rip detection system is shown of the type taught in U.S. Pat. No. 6,715,602, incorporated herein by reference in its entirety. The system 30 includes a conveyor belt 32 moveable in the direction indicated at 34 in the manner described above. The motor, motor controller, and roller drive system (not shown) are as shown in U.S. Pat. No. 6,352,149. The system includes a transponder and antenna system 36 that includes a pair of concentric antennae/sensor loops 38, 40 and a pair of ID transponders 42, 44. The transponders 42, 44 are integrated into respective elongate semiconductor chips having an integral coupling coil by which both transponders may be electromagnetically coupled to both the loops 38, 40. In the preferred embodiment, the transponders 42, 44 are located and coupled to opposite longitudinal sides of the loops 38, 40 in mutually offset relationship. The loops 38, 40 are generally rectangular and sized to span the width of the belt.

A pair of detectors 46, 48 are mounted adjacent the belt 32 in the positions shown. Detector 46 is disposed over conductor loops 38, 40 at one side of the belt 32 and detector 48 is positioned over the transponders 42, 44 at an opposite side of the belt 32. Leads 50, 52 from the detectors 46, 48, respectively, input through junction box 54 and feed via lead 56 to a motor control unit (not shown).

The subject transponders 42, 44 operate at a frequency of 13.56 MHz and are commercially available. By example and without limitation, a suitable transponder is manufactured by GEMPUS, BP100-13881 Gemenos Cedex, France, and marketed carrying the product code G+Rag Series 200 AR10 10LM. Other commercially available transponders may be substituted. The use of a relatively high frequency allows for the utilization of smaller detector sizes. The transponders shown transmit a 16-bit digital, alphanumeric identification signal when energized by an appropriate field. The transponders 42, 44, as explained previously, are each fabricated into an elongate respective chip having an output coupling coil. The transponders are encoded with an identification code and may be inductively energized by a remote transmitter. The transponders 42, 44 are electromagnetically coupled through their respective output coils to both the loops 38, 40 and induce their respective identification signals into the conductor loops when energized.

The subject reader/detectors 46, 48 are of a type commercially available and are positioned relative to the loops 38, 40 as shown in FIG. 2. Detectors manufactured and sold by Phase IV Engineering, 2820 Wilderness Place, Unit C, Boulder, Colo. 80301 under the product identification conveyor tag reader are suitable and other known commercially available readers may be substituted if desired. A coupling occurs only when the antenna loops 38, 40 pass across the detector heads 46, 48 and can only occur when the loop integrity has not been compromised. During normal operation, the two detector heads 46, 48 are mounted between approximately 1 inch and 11 inches from the edges of the belt. The transponders 42, 44 are passive and receive their operating energy from a signal induced into the loops 38, 40 by a remote transmitter (not shown). Once activated, the transponders 42, 44 induce an identification number into both conductor loops 38, 40 which are detected by reader/detector 48. Two transponders and two coupled conductor loops 38, 40 comprise each sensor along the belt in the preferred embodiment for the sake of redundancy. Should such redundancy not be deemed desirable, a series of single transponder to sensor loop coupled pairs may be employed in the practice of the invention.

The second detector head 46 is mounted over the opposite side of the belt and reads loops 38, 40 to determine whether or not the induced identification signal from the transponders 42, 44 is present. If the loop is not intact, the signal will not be carried by the loop and the second sensor head will not detect the signal. A conclusion that the loops 38, 40 have been damaged is thus drawn.

Output from the detectors 46, 48 is relayed via leads 50, 52 through a junction box 54 and output lead 56 to a control unit (not shown). The control system cross-references the identification number provided by transducers 42, 44 to a specific location on the belt. If the loops 38, 40 are not intact, the control unit (such as 27 in FIG. 1B) would shut the belt down via a relay and indicate a “rip stop”.

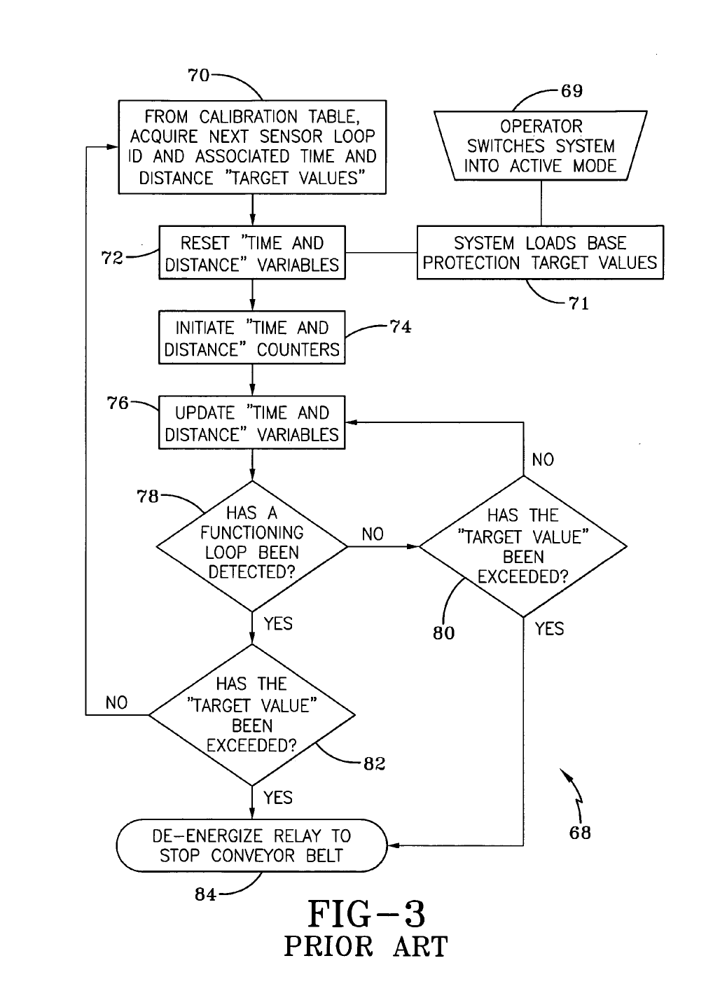

FIG. 3 presents a schematic 68 of the logic for a prior art system. The precise location of each coupled sensor loop/transponder is known and may be programmed into computer memory. In the prior art system, an operator switches the system into an Active Mode 69. From a Calibration Table, the next sensor loop ID and associated time and distance “Target Values” are obtained 70. The time and distance variables that determine where the next transponder/sensor loop is determined is reset 72 based upon Base Protection Target Values loaded by the system 71. Time and distance counters are initiated 74 and time and distance variables updated 76. The system will know based upon data stored in memory the identity and estimated location of the next sensor/transponder pair in the belt. The system will transmit an energizing signal to the transponder(s) that will trigger an induction of an identification signal by the transponder into the loop(s). If two transponders and two concentric sensor loops are employed, an identification signal will appear in both sensor loops. Should one of the transponders or loops be damaged, the presence of the signal in the surviving loop will be detected and the system will conclude no breach in belt integrity has occurred. Should both loops/transponders be damaged, however, no signal will be detected and the system will conclude that a breach in belt security has occurred.

The system monitors each sensor loop(s) and decides 78 whether a functioning loop has been detected. If a functioning loop is not detected, the system determines whether the “Target Value” based upon “Time and Distance” has been exceeded 80. In the event the values for time and distance have been exceeded, a de-energizing relay signal to stop the belt 84 is given. If the values have not been exceeded, the loop reverts back to update “Time and Distance” variables 76. When a functioning loop is detected 78 and the target value exceeded 82, the belt is stopped 84. If the loop is detected and the Target Values not exceeded, the process loops back to acquire the next loop ID and associated time and distance “Target Values”.

In the prior art system, the belt is stopped whenever there is a failure to excite the RFID tag; there is a malfunction of the RFID tag; or there is a break in a sensor loop. In short, RFID failure, not necessarily a break or failure of the conveyor belt or sensor loop, may cause the detection system to institute a belt stoppage. Such action is not warranted when the failure is in the RFID tag associated with each sensor loop.

In addition, identification of sensors in the belt using a memory map of the belt sensor locations may not be accurate if certain RFID tags malfunction or operate intermittently. As a conveyor belt ages, it is not uncommon for RFID tags to fail or operate intermittently. In the system of FIG. 3, failure of an RFID tag will cause the system to mis-identify the next appearing, functional sensor, believing the tag to be at a position of the failed tag on the belt, rather than the correct position. When this happens, the identification of belt sensors falls out of synchronization with the memory map that identifies the location of each sensor within the belt. The ability of the system to reliably and accurately locate where a belt breakage has occurred is thus compromised.

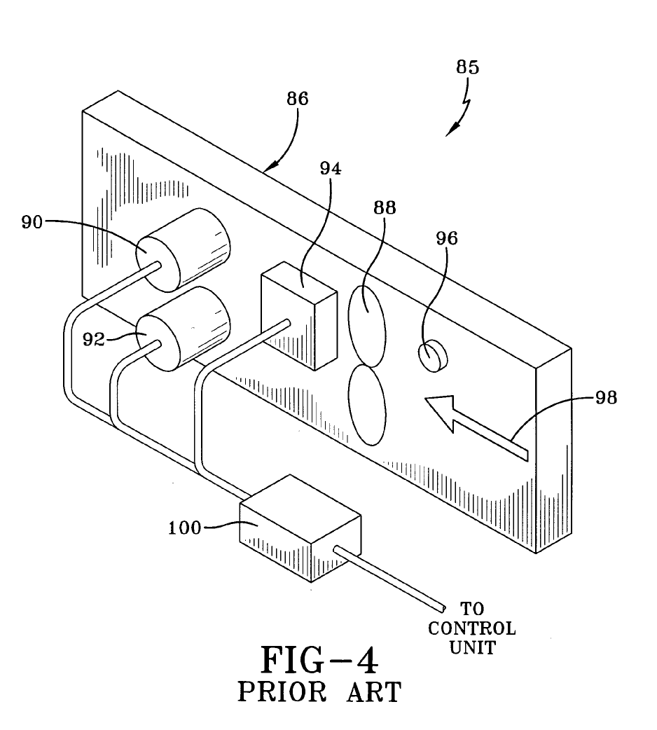

With reference to FIG. 4, a prior art conveyor belt rip detection system is shown of the type taught in U.S. Publication No. 2007/0102264, incorporated herein by reference in its entirety. The system 85 includes a conveyor belt 86 having a plurality of embedded sensors 88 spaced along the belt 86. The sensor, detector, reader, and tag components may be sourced from the same commercial sources as previously described in reference to the prior art. The sensor 88 functions as described above; namely a rip or tear in the belt at the location of sensor 88 will damage one or both of the coils in sensor 88. Two detector heads 90, 92 are positioned to detect the status of a respective loop in the sensor 88 as the sensor 88 passes proximally to the heads 90, 92. The heads 90, 92 then transmit information concerning the status of sensor 88 to junction box 1 00 for relay to a processing unit (not shown). A read head 94 is disposed to detect and identify a RFID tag 96 in the belt 86 as the tag 96 passes proximally. The head 94 transmits information concerning the detection and identity of the tag 96 to the junction box 100 for relay to a processing unit.

It will be appreciated that a plurality of the RFID tags 96 is intended to be spaced along the belt 86 at locations maintained in a computer memory map. Likewise, the locations of the sensors 88 are maintained in the computer memory map. The number of tags 96 may, but need not necessarily, equate with the number of sensors 88 and the spacing of the tags 96 may, but need not necessarily, equate with the spacing between the sensors 88 along the belt. A calibration table is stored within system memory whereby the distances between an identified tag and each sensor 88 in the belt may be ascertained. Each tag 96 is thus a synchronizing reference point along the belt. Upon detection and identification of a tag 96 by the reader 94, at a given speed of belt movement in direction 98, associated time and distance “target” values may be acquired by reference to the memory map (calibration table) for each sensor 88 in the belt. That is, the subject system uses the RFID tags as reference addresses in the belt. Locating a tag allows the system to synchronize the belt with the software memory. The system detects and identifies a tag 96 for the sole purpose of generating time and distance target values for sensors 88 in relationship to the detected and identified tag.

Since the spatial relationship of each sensor relative to each tag 96 in the belt is stored in the calibration table, time and distance target values may be acquired from the calibration table using any of the tags 96 as a reference point. A malfunction of one or more tags 96 over time will not affect the capability of the system to physically correlate exact belt position to the stored data within the system memory. Any of the remaining tags may be used to correlate the system memory with the physical belt. On the contrary, some current systems rely on the detection of tags in order to conclude that an embedded sensor is in good working condition. Failure of a tag is interpreted by such systems as a failure in the sensor loop. Such systems signal that movement of the belt cease in such instances, perhaps unnecessarily. Unnecessary and costly shutdowns result. In addition, should a tag malfunction in an existing system, the system will interpret the location of the next tag as being the location of the prior malfunctioning tag. The position of the belt relative to the memory map of the system is thereby incorrect and the system cannot recover to reconcile the incongruity between the memory map and actual belt position.

The system as described in FIG. 4 uses the tags to synchronize the position of the belt with the memory map of the belt in the sensor system. This becomes important when a conveyor system ages and sensors become intermittent. Intermittent sensors can result in the memory map of the belt in the sensor system to differ from the actual position of the belt. The system will find itself looking for a different embedded sensor in its memory than the actual sensor that is passing by the detector heads. The system is thus no longer synchronized. By utilizing the RFID tags as reference locations, the present invention is self-synchronizing based on the address of any RFID tag and the location of that tag in the system memory. The tags thus facilitate locating and replacing intermittent or non-functioning sensors in the belt.

The subject system is self-calibrating. The identification tags, as described below, are spaced along the belt and pass a tag reader which detects and identifies each sensor tag as it passes. The reader detects and identifies the presence of each sensor as it passes the reader and associated sensor separations in time and distance are made. The time and distance counters for individual sensor separation are recorded. This calibration process continues until a repeating pattern of sensor tags is detected and identified. The pattern of tags and sensors within the belt is thus updated and stored in memory each time a self-calibration is made. Missing tags or sensors or damaged tags/sensors that are not detected and identified will be noted. By updating the sensor/tag map of the belt in terms of distance of sensors from each tag, an accurate status of the belt sensor array may be maintained throughout the life of the belt.

In addition, the subject system can operate to automatically skip a sensor in event that a first sensor (S1) is not detected and identified within the time and distance target values. When the “Skip 1” mode is active, associated time and distance target values for a second sensor (S2) is measured from the identified functioning tag in the event that the sensor (S1) is detected and identified within the time and distance target values. In the event that sensor (S1) is not detected and identified within the time and distance target values, however, the system automatically (in the Skip 1 mode) acquires associated time and distance target values for a second sensor (S2) as measured from the identified functioning tag, essentially skipping the non-detected sensor (S1). Thus, the system can continue to use the stored sensor/tag map even as sensors begin to fail during the life of the belt.

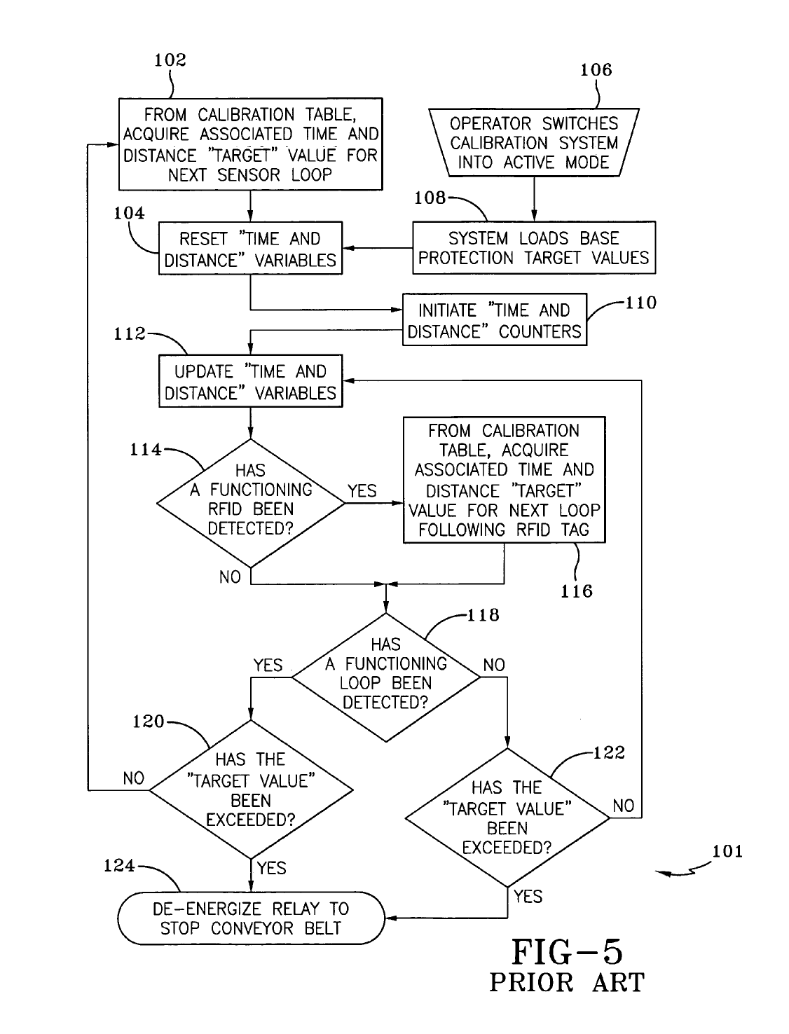

FIG. 5 shows in block diagram 101 the functioning of the sensor system 85 shown in FIG. 4. From a calibration table, associated time and distance target values for a next sensor loop (S1) is acquired 102. Time and distance variables are reset 104 and initiated 110 when an operator switches a calibrated system into active mode 106 and the system loads standard distance protection target values 108. The standard distance protection operates until the first tag is detected and the system synchronizes. Pursuant to the method, the system then determines whether a functioning RFID tag has been detected (114). If so, from the system calibration table (memory map), associated time and distance target values are acquired for the next sensor following the RFID tag, using the RFID tag as a reference point 116. The system then determines whether a functioning sensor has been detected 118. If so, a determination is made as to whether the sensor has been detected within the target values 120 and the system loops back to acquire associated time and distance target values for the next sensor loop (S2). The process is thereupon repeated. Should the target values for S1 be exceeded at 120, a relay command to stop the conveyor belt is given 124.

In the event that a functioning sensor S1 is not detected 118, a determination is made as to whether the target time and distance values have been exceeded 122. If they have not, the system feeds back to update time and distance variables 112. If the time and distance values are exceeded, the system again will issue a signal to stop the conveyor belt 124. Note that the non-detection of a functioning RFID tag 114 will not automatically result in a shutdown of the conveyor line. Rather, the system will continue to measure time and distance from the previous reference tag to determine whether subsequent functioning loop sensors are present within the time and distance target values. In addition, the conveyor will only be stopped if the time and distance target values from the reference RFID tag location are exceeded 120, 122. Thus, the system can use each RFID tag as a reference location on the belt in addition to the incoming sensor loop detection, for the purpose of acquiring the correct time and distance target values, until replaced by the next loop or functioning RFID tag.

Many of the prior art sensor systems utilize a single cord loop to form the sensors/conductors/antennae, such as sensors 16, 38, 40, and 88 shown in FIGS. 1A, 1B, 2 and 3. As noted above, such single cord loops are susceptible to high resistance, and thus intermittent operation, as the conveyor system wears and the single cord loop fatigues. Moreover, single cord loops that sustain breakage without an associated rip in the conveyor belt unnecessarily shut down the belt. Furthermore, under the standard distance mode of operation (e.g., protects up to largest separation distance of sensors), when a sensor fails, the protection distance dramatically increases (e.g., doubles for regularly spaced sensors). Thus, the length of a rip which may exist before detection by the sensor system increases.

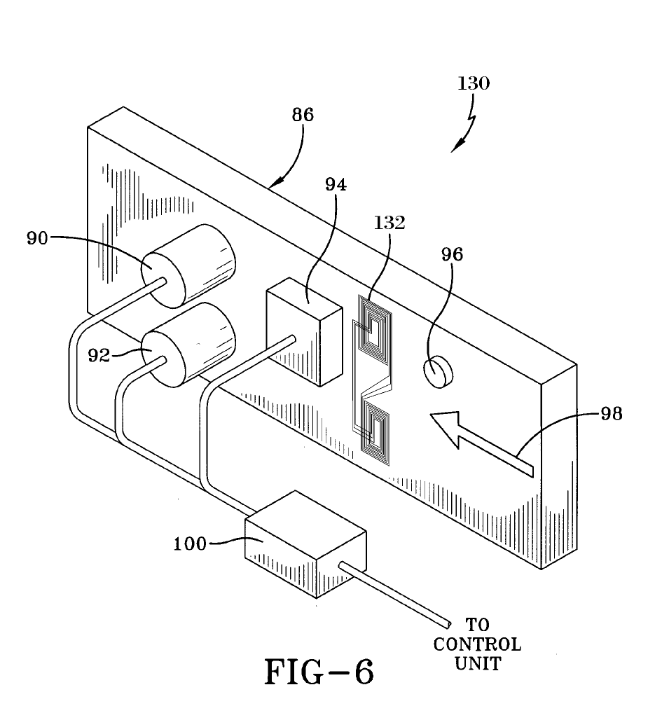

With reference to FIG. 6, a conveyor belt rip detection system 130 in accordance with an embodiment of the invention is shown. The system 130 is similar in structure and operation to system 85 shown and described in FIG. 4 and similar reference numbers are used to indicate similar features. The primary difference between the systems 85, 130 is that the conveyor belt rip detection system 130 utilizes a sensor/conductor/antenna 132 in accordance with aspects of the invention that addresses some of the shortcomings of single cord loops.

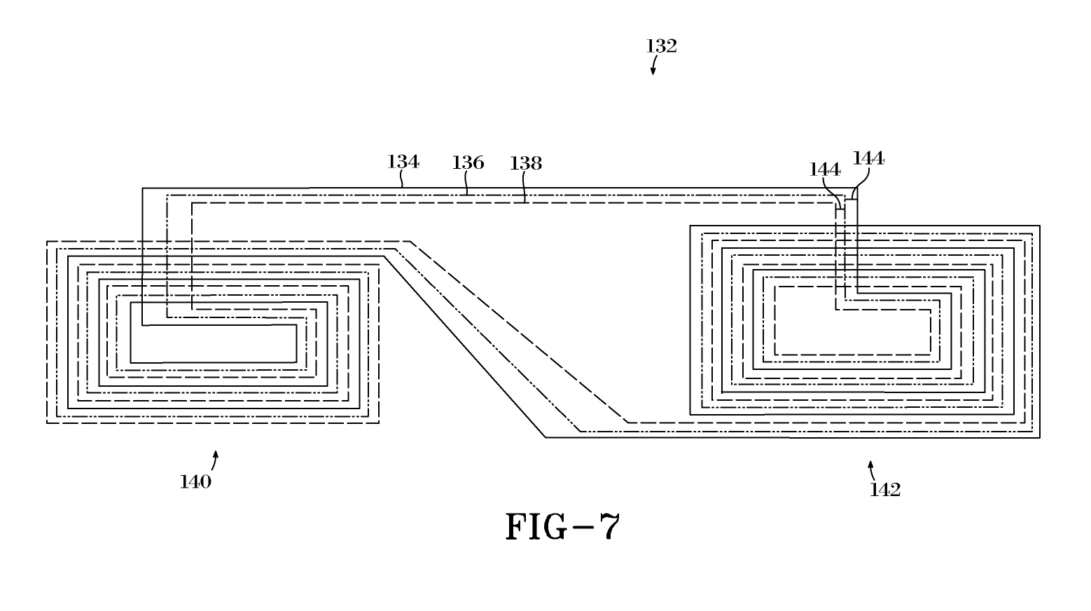

In this regard, an exemplary sensor 132 is shown in FIG. 7 and includes a plurality of independent cords 134, 136, 138 each having multiple generally rectangular coils 140, 142 (two shown) to collectively form a signal inverting type of sensor 132. Although the sensor 132 shown in FIG. 7 illustrates three such cords, the sensor 132 may include at least two cords or more than three cords, depending on the specific application. Thus, the invention should not be limited to the specific number of cords illustrated in FIG. 7. In an exemplary embodiment, the cords 134, 136, 138 may have a nested configuration. Moreover, although each coil 140, 142 includes three loops or passes for each of the cords 134, 136, 138, the number of loops in each of the coils 140, 142 may vary depending on the particular application. It may be preferable, however, for each of the coils 140, 142 to have three or more passes as the efficiency of generating and sensing a signal within the sensor, such as by a transmitter/exciter and receiver/detector, increases as the number of passes of the coils 140, 142 increases. Furthermore, although each of the coils 140, 142 is shown having a generally rectangular shape, those of ordinary skill in the art will recognize that other shapes are possible.

The multiple, independent cords (e.g., three such cords) provide redundancy to the sensor 132. Thus, should one of the cords 134, 136, 138 fail without a corresponding failure in the belt (e.g., wear or localized event), the sensor 132 is still capable of operating via the remaining cords. Accordingly, unnecessary shut downs of the conveyor belt, and the associated costs, downtime, etc., may be avoided. The nested configuration of the cords 134, 136, 138 facilitates an arrangement wherein the cords 134, 136, 138 operate in “parallel” with each other. Such a parallel configuration between the cords 134, 136, 138 provides a net reduction in the overall resistance of the sensor loop 132. Although the nested configuration as illustrated in FIG. 7 facilitates a parallel arrangement between the cords 134, 136, 138, those of ordinary skill in the art may recognize other configurations that result in a parallel arrangement between the cords.

In one embodiment, each of the cords 134, 136, 138 may be formed from metal strands or filaments having a standard cord construction, such as a 7×7 type of cord construction. The strands may be formed from stainless steel or other electrically conductive materials as recognized by those of ordinary skill in the art. Moreover, those of ordinary skill in the art will appreciate that other cord constructions in addition to the 7×7 construction are possible. The two corresponding ends of each of the cords 134, 136, 138 may be joined together to form an endless loop. The joint may be made, for example, by braiding, soldering or by a mechanical connector, all of which are known in the electrical trades. In an alternate embodiment, each of the cords 134, 136, 138 may be formed from at least one microcoil spring wire, as more fully disclosed in U.S. Pat. No. 6,352,149. Each cord 134, 136, 138 may also be formed from more than one microcoil spring wire. While it is contemplated that each of the cords 134, 136, 138 will have a similar design, the invention is not so limited as each of the cords may have a different design.

As noted above, the cords 134, 136, 138 have a nested configuration that facilitates a parallel arrangement between the cords. In this regard, the sensor 132 further includes electrically conductive cross connectors 144 that electrically connect the cords 134, 136, 138 and achieve the parallel configuration. The cross connectors 144 may have the same cord construction as cords 134, 136, 138 (e.g., 7×7 cord construction, microcoil spring wire). Alternatively, the cross connectors 144 may have other configurations that electrically connect the cords 134, 136, 138, such as electrically conductive adhesives, pastes, etc. Further, although FIG. 7 shows only one cross connector between a corresponding pair of cords, more than one cross connector may be provided for each pair of connectors. The parallel configuration of the cords 134, 136, 138 reduces the overall resistance of the sensor 132. As is well recognized in the electrical arts, resistive elements placed in parallel decrease the overall resistance of the system. Providing a sensor having a low or reduced resistance may provide benefits in conveyor belt rip detection systems.

For example, as noted above in single cord sensor systems, as the conveyor belt ages, the cord that forms the sensor begins to deteriorate resulting in an increased electrical resistance of the cord. As the resistance of the cord increases, the signal transmitted by the cord essentially becomes weaker. If the resistance is sufficiently high, the signal carried by the cord will fall below a threshold value capable of being read by the detectors (e.g., detectors 90, 92 in FIG. 4). As a result, the sensor will not be detected and the conveyor belt stopped even though there is no failure in the belt. The reduced resistance of sensor 132 due to the parallel configuration essentially delays the onset of unnecessary stoppages due to the inability to read a sufficiently weakened signal through a cord. In other words, as the conveyor belt wears and the cords begin to deteriorate, the resistance of the sensor 132 remains below a critical value that results in the inability to read the signal in the cords for a period of time that exceeds that of single cord sensors. Thus, operation of the conveyor belt without unnecessary stoppages due to the failure to read a sensor is extended.

Thus, in accordance with aspects of the invention, sensor 132 provides a number of benefits for conveyor belt rip detection systems. For example, the multiple cords provide a redundancy feature that allows the sensor to continue operating even though one of the cords has broken (e.g., due to wear of local event). Moreover, the parallel configuration of the cords reduces the overall resistance of the sensor 132 so as to extend the life of the sensor as the conveyor belt wears. Each of these features avoids or reduces the unnecessary stoppages of the conveyor system as compared to existing single cord loops. Moreover, because the life of the sensor is extended, the sensor system is capable of protecting to a shorter protection distance for an extended period of time when under a standard distance mode of operation. Thus, in such an operating mode, the system is capable of identifying smaller rips in the conveyor belt for a longer period of time as compared to single cord loop systems.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. Thus, the various features of the invention may be used alone or in numerous combinations depending on the needs and preferences of the user. What is claimed is:

1. A conveyor belt including at least one rip detection sensor, the sensor comprising:
at least two cords, each cord formed in an endless loop and arranged in a signal inverting configuration; and
at least one cross connector electrically connecting the at least two cords so as to arrange the at least two cords in a parallel configuration that reduces the overall resistance of the at least one sensor.

2. The conveyor belt of claim 1, wherein the at least two cords have a nested configuration.

3. The conveyor belt of claim 1, wherein at least one of the cords is formed from at least one microcoil spring wire.

4. The conveyor belt of claim 3, wherein the at least one cord is formed from a plurality of microcoil spring wires.

5. The conveyor belt of claim 3, wherein each of the at least two cords is formed from microcoil spring wire.

6. The conveyor belt of claim 1, wherein a plurality of cross connectors connects a pair of the cords.

7. The conveyor belt of claim 1, wherein the conveyor belt includes a plurality of sensors spaced at intervals along the conveyor belt.

8. A conveyor belt rip detection system, comprising:
a conveyor belt; and
at least one sensor associated with the conveyor belt, the sensor including at least two cords, each cord formed in an endless loop and arranged in a signal inverting configuration, and at least one cross connector electrically connecting the at least two cords so as to arrange the at least two cords in a parallel configuration that reduces the overall resistance of the at least one sensor.

9. The conveyor belt rip detection system of claim 8, further comprising:
an external transmitter/exciter configured for inducing a signal in the sensor; and
a first external receiver/detector configured for detecting the presence of a signal induced in the sensor by the transmitter/exciter to monitor the integrity of the cords.

10. The conveyor belt rip detection system of claim 9, further comprising:
a second external receiver/detector configured for detecting the presence of a signal induced in the sensor by the transmitter/exciter to monitor the integrity of the cords.

11. The conveyor belt rip detection system of claim 9, further comprising:
a drive motor;
a driven roller driven by the drive motor;
a following roller; and
control circuitry connected between the first receiver/detector and a drive motor controller configured for controlling the action of the drive motor.

12. The conveyor belt rip detection system of claim 8, wherein the at least two cords have a nested configuration.

13. The conveyor belt rip detection system of claim 8, wherein at least one of the cords is formed from at least one microcoil spring wire.

14. The conveyor belt rip detection system of claim 8, wherein a plurality of cross connectors connects a pair of the cords.

15. The conveyor belt rip detection system of claim 8, wherein the conveyor belt includes a plurality of sensors spaced at intervals along the conveyor belt.

16. A method of manufacturing a sensor system for a conveyor belt, comprising:
providing at least one sensor, the at least one sensor including at least two cords, each cord formed in an endless loop and arranged in a signal inverting configuration, and at least one cross connector electrically connecting the at least two cords so as to arrange the at least two cords in a parallel configuration that reduces the overall resistance of the at least one sensor; and
embedding the at least one sensor within the conveyor belt.

17. The method of claim 16, further comprising:
providing a transmitter/exciter for inducing a signal in the sensor.

18. The method of claim 17, further comprising:
providing an external receiver/detector for detecting the presence of a signal induced in the sensor by the transmitter/exciter to monitor the integrity of the cords.

19. The method of claim 18, further comprising:
providing a controller to immobilize the conveyor belt in the event a discontinuity in the at least two cords of the sensor is detected.
